(19) United States
(12) Patent Application Publication
(10) Pub. No.: US 2007/0181864 A1
(43) Pub. Date: Aug. 9, 2007

(54) SCREW JACK ASSEMBLY

(75) Inventor: CHARLES RAY BARTEE, MOUNTAIN HOME, ID (US)

Correspondence Address: DYKAS, SHAVER & NIPPER, LLP, P.O. BOX 877, BOISE, ID, 83701-0877, US

(73) Assignee: ANDREW TAYLOR, QUEENSLAND (AU)

(21) Appl. No.: 11/426,971

(22) Filed: Jun. 28, 2006

Related U.S. Application Data
(60) Provisional application No. 60/694,349, filed on Jun. 28, 2005.

(51) Int. Cl. B60S 9/02

(52) U.S. Cl. 254/424

(57) ABSTRACT

A screw jack assembly (10) for a towed vehicle (100) has a spring housing (30) and a leg section (20) (which may be fitted with a castoring jockey wheel (120) or foot (130) in telescopic relationship, and a compression spring (40) is compressed so that the position of the spring housing (30) relative to weight indicating indicia (20) on the leg section (20) can indicate the tongue weight of the towed vehicle (100). By locking the spring housing (30) and leg section (20) together, a crank shaft (50) can move a main housing (80) relative to the leg section (20) to enable the assembly (60) to raise and lower the vehicle (100) in the manner of a conventional screw jack assembly.

### RELATED APPLICATIONS

This application claims the priority of U.S. Provisional Patent Application Ser. No. 60/694,349, filed Jun. 28, 2005, the contents of the Provisional Application being included in this application by reference.

### BACKGROUND OF THE INVENTION

1. Field of the Invention

This invention relates to a screw jack assembly.

The invention particularly relates, but is not limited to, a screw jack assembly mountable on the drawbar of a vehicle, such as a trailer, caravan, camper trailer, horse float or such like towed vehicle, where the screw jack assembly can be operated to indicate the tongue weight at a towing coupling on the drawbar.

2. Prior Art

Screw jack assemblies are commonly used to support the drawbars of towed vehicles, when the latter are not in use, to enable easy connection, or release from, a towing vehicle,

Transport authorities establish regulations for the towing of vehicles. For example, depending on whether or not the towed vehicles are provided with brakes, and the types of brakes, the maximum gross towed weight cannot exceed different percentages (eg., 50%/100%/150%) of the towing vehicle weight.

Tow system manufacturers have class ratings (eg., classes I to IV) for different tongue weights, where the tongue weight is the amount of downward force applied by the towing coupling (eg., towing socket)to the complementary towing coupling (eg., tow ball) of the towing vehicle. Overloading the towing system, including exceeding a maximum allowable tongue weight, is not only illegal but can result in damage to the towing vehicle (eg., automobile or truck),its tow system and the towed vehicle (eg., trailer).

An excessive tongue weight can cause the steering (and front-driving) wheels of the towing vehicle to suffer reduced braking/steering/traction. If the headlights are not adjusted, their projection patterns can be raised and cause problems for oncoming drivers.

In extreme cases, the towed vehicle may become disconnected from the towing vehicle, with the potential for injuries to both persons and property.

### SUMMARY OF THE INVENTION

It is an object of the present invention to provide a screw jack assembly which enables a user to determine the tongue weight of a towed vehicle to which it is fitted.

It is a preferred object to provide such an assembly which can be used as a conventional jack for a drawbar of a towed vehicle.

It is a further preferred object to provide such an assembly which incorporates a level indicator, so that consistent tongue weight measurements are possible.

It is a still further preferred object to provide such an assembly which is easy to use, and which can be manufactured at a competitive cost relative to known screw jack assemblies.

Other preferred objects will become apparent from the following description.

In one aspect, the present invention resides in a screw jack assembly for a vehicle, including:

a leg section, mountable at a lower end on a foot or jockey wheel;

a spring housing, having a tubular body, mountable on the vehicle, the tubular body having a cap at one end and being in co-axial telescopic arrangement with an upper end of the leg section at a second end of the tubular body;

at least one compression spring within the tubular body of the spring housing and interposed between the cap and the upper end of the leg section; and

weight indicating indicia on the leg section adjacent the second end of the tubular body of the spring housing; so arranged that:

a weight applied to the spring housing by the vehicle causes compression of the at least one compression spring;

whereby relative movement of the second end of the tubular body of the spring housing to the weight indicating indicia provides a measurement of the weight.

Preferably, where the screw jack assembly is mounted on a drawbar of the vehicle, for towing, the weight measured is the tongue weight at a towing coupling on the drawbar.

Preferably, a spring guide/stop tube is connected to the cap and extends co-axially within the at least one compression spring and is operable to engage the upper end of the leg section at a maximum measurable weight.

Preferably, at least one retainer pin or safety clip is engageable in aligned holes in the tubular body of the spring housing and the leg section to releasably lock the spring housing to the leg section when the screw jack assembly is operable to raise or lower the vehicle.

Preferably, the cap has a screw-threaded bore therethrough; and a crank shaft, having a shank with external screw-threads, is rotatably engaged in the screw-threaded bore in the cap, the crank shaft having an operating handle at a distal end of the shank and a radially extending shoulder or peripheral flange between the distal end and the cap.

Preferably, the main housing has a tubular housing body which substantially encloses the spring housing and has a top end plate at an upper end with a co-axial bore therethrough, through which the crank shaft extends.

Preferably, an annular inner face on the top end plate engages the radially extending shoulder or peripheral flange on the crankshaft, whereby rotation of the crank shaft moves the main housing towards, or away from, the leg section to vary the effective length of the screw jack assembly.

Preferably, a thrust bearing or bush is interposed between the annular inner face on the top end plate and the radially extending shoulder or peripheral flange on the crank shaft.

Preferably, an inwardly directed projection on the housing body of the main housing engages a complementary elongate recess in the tubular body of the spring housing to maintain the main housing and the spring housing in a telescopically slidable, but non-rotatable, relationship.

Preferably, a mounting plate projects substantially radially from the housing body of the main housing to enable the screw jack assembly to be mounted on the vehicle.

Preferably, a bubble level or other level indicator is provided on the screw jack assembly to indicate the vehicle is in a correct orientation to enable consistent measurement of the weight.

### BRIEF DESCRIPTION OF THE DRAWINGS

To enable the invention to be fully understood, a preferred embodiment of the invention will now be described with reference to the accompanying drawings, in which:

FIG. 1 is a side elevational view of the screw jack assembly, fitted with a castoring jockey wheel, and fitted to the drawbar of a trailer (or other towed vehicle);

FIG. 2 is a similar view of the screw jack assembly on a larger scale;

FIG. 3 is a sectional side elevational view of the screw jack assembly, fitted with a hinged foot; and

FIG. 4 is an exploded perspective view of the components of the screw jack assembly.

### DETAILED DESCRIPTION OF THE PREFERRED EMBODIMENTS

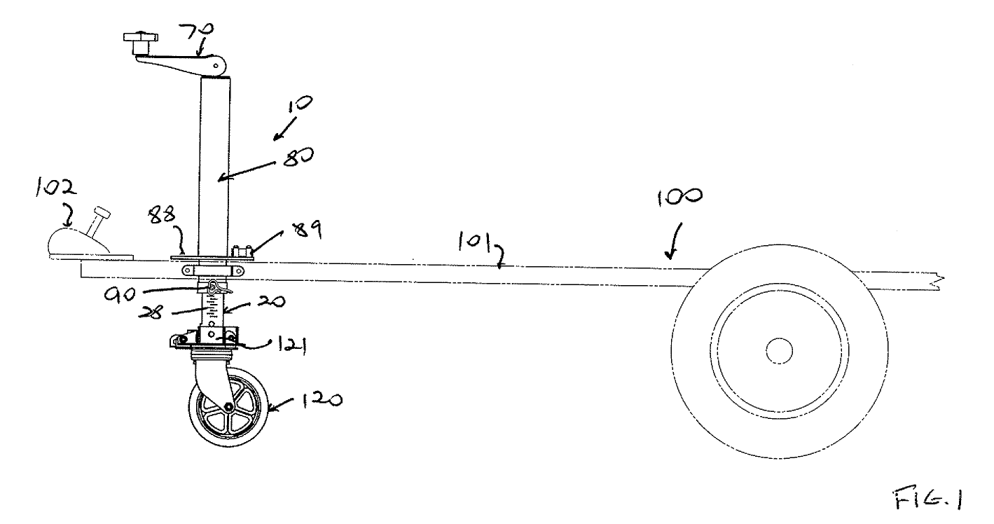

The screw jack assembly 10, to be hereinafter described in more detail with reference to FIGS. 1 to 4, is shown in FIG. 1 mounted on the drawbar 101 of a towed vehicle 100, such as a trailer, caravan, campervan or horse float; where the tongue weight of the towing coupling 102, which is transferred to a complementary towing coupling (e.g., a towball) of a towing system of a towing vehicle, such as an automobile, sports utility vehicle (SUV) or truck, not shown, can be displayed.

The tongue weight is preferably measured when the towing coupling 102 is at a designed towing height, as indicated by a bubble level or like level indicator (to be hereinafter described), where the drawbar 10 is typically substantially horizontal.

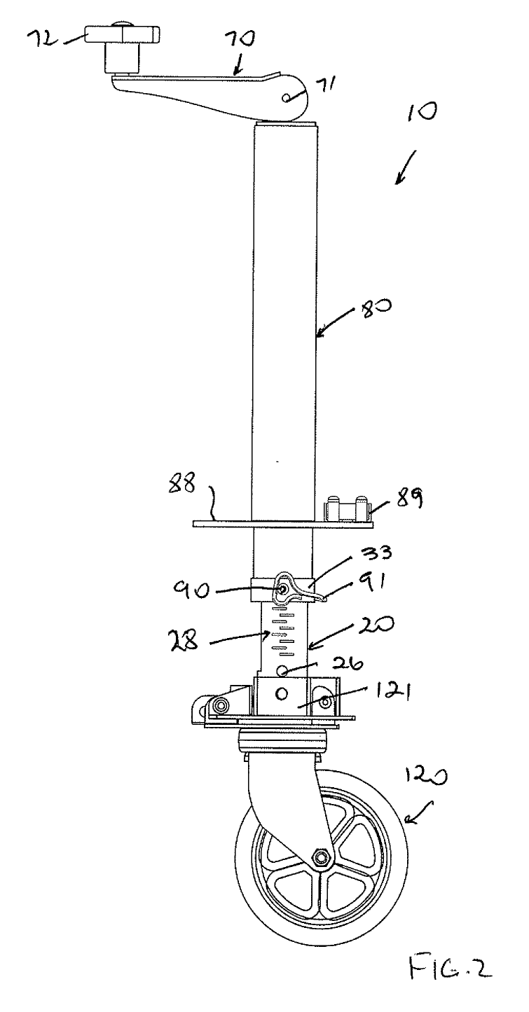

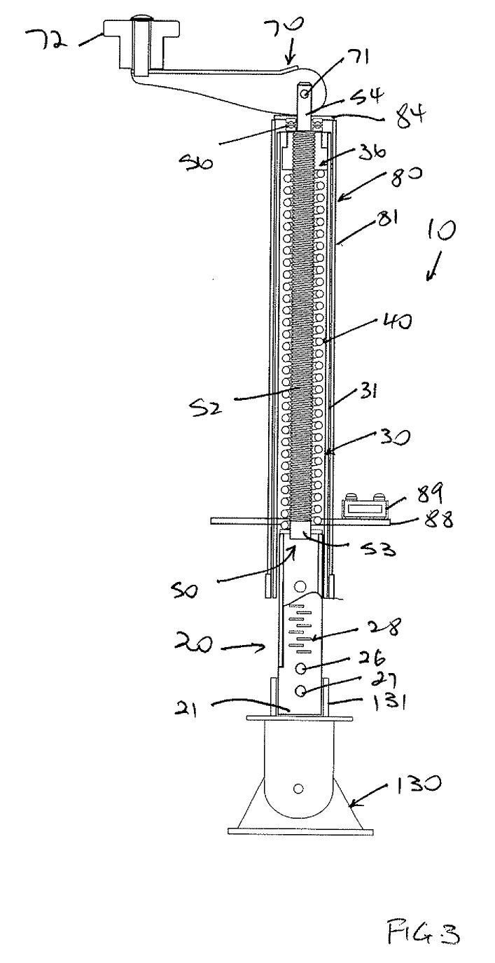

As shown in FIGS. 1 and 2, the screw jack assembly 10 may be provided with a (preferably lockable) castoring jockey wheel 120; while as shown in FIG. 3, the screwjack assembly 10 may be provided with a hinged foot 130.

The screw jack assembly 10 has a leg section 20, preferably formed of a tubular metal section, where the lower end 21 of the leg section 20 is received in a mounting socket 121 for the castoring jockey wheel 120, as shown in FIGS. 1 and 2, or in a mounting socket 131 for the hinged foot 130. The upper end 22 of the leg section 20 has a top plate 23 with a central hole 24.

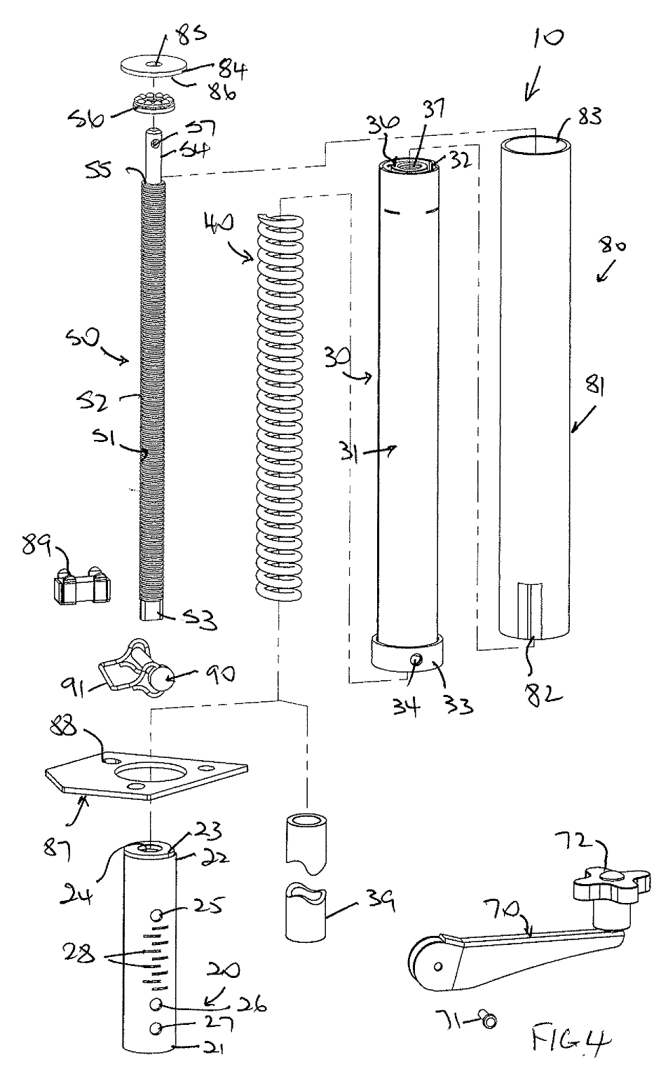

Pairs of vertically spaced, aligned holes 25, 26, 27 are provided through the leg section 20, as shown in FIG. 4.

Weight indicating indicia 28, in the form of grooves, projections, or printed markings, are provided on at least one portion of the leg section 20; where the weight indicating indicia may be provided to indicate the tongue weight in 50 lb/100 lb/25 kg50 kg or like intervals (with the tongue weight in increasing order down the leg section 20 to a maximum indicatable tongue weight).

A spring housing 30 has a tubular body 31 with a shallow elongate recess 32 down one side (for the purpose to be hereinafter described).

A retainer ring 33, with a pair of aligned holes 34, is fixed to the second (lower end) 35 of the tubular body 31.

A cap 36, with a screw-threaded bore 37, is fixed to the first (upper) end 38 of the tubular body 31.

A spring guide/stop tube 39, as shown in FIG. 4, may be connected to the under side of the cap 36, co-axial with the screw-threaded bore 37 and extend downwardly from the cap 36.

A compression spring 40, or two or more interwound compression springs, is interposed between the underside annular face of the cap 36 and the upper face of the top plate 23 of the leg section 20. (When the spring guide/stop tube 39 is provided within the spring housing 30, the upper end of the compression spring 40 is received in the annular cavity defined by the tubular body 31 of the spring housing 30 and the spring guide/stop tube 39. The spring guide/stop tube 39, engages the top plate 23 of the leg section 20 at the maximum allowable compression of the compression spring 40 to prevent failure of the latter.) A crank shaft 50 has a shank 51 with external screw threads 52 complementary to the screw threads of the screw-threaded bore 36 of the cap 35. A lower end 53 of the shank 51 is rotatably journalled in the hole 24 in the top cap 23 of the leg section 20.

A cylindrical upper end 54 of the shank 51 is connected to the adjacent portion of the shank 51, with the screw threads 52, by a radially extending shoulder 55 which supports a thrust bearing 56.

A transverse hole 57 in the cylindrical upper end receives a pivot pin 71 of a foldable handle 70, which has a knurled knob 72 at its distal end. When required to operate the screw jack assembly 101 the foldable handle 70 is moved to the operating position (substantially radial to the crank shaft 50) as shown in FIGS. 1 to 4; while it can be folded to an inoperative position substantially parallel to the screw jack assembly 10 when not in use.

A main housing 80 has a tubular housing body 81 with a short, shallow, inwardly-directed projection 82. The inwardly-directed projection 82 is aligned with the elongate recess 32 in the tubular body 31 of the spring housing 30 to provide an anti-rotation device when the tubular housing body 81 of the main housing 80 is located co-axially around the spring housing 30.

The upper end 83 of the main housing 80 is closed by a top end plate 841 with a central bore 85 through which the cylindrical upper end 54 of the crank shaft 50 extends. The thrust bearing 56 engages the annular inner face 86 of the top end plate 84.

A mounting plate 87 is attached to, and extends substantially radially from, the tubular housing body 81 of the main housing 80 and is provided with holes 88 for mounting of the screw jack assembly 10 the drawbar 101 by suitable fasteners (not shown). A bubble level 89 or other 5 suitable level indicator is provided on the mounting plate 87 to indicate when the drawbar 101 is at the designed towing level, to enable consistent measurement of the tongue weight of the towing coupling 102.

A retaining pin 90, with a safety clip 91, can be passed through the holes 34 in the retaining ring 33 and the holes 25, 26 and 27 in the leg 10 section 20, to releasably lock the spring housing 30 to the leg section 20 when the screw jack assembly 10 is to be operated as a conventional screw jack to raise or lower drawbar 101 (or to support the drawbar 101 when the vehicle 100 is not connected to the towing vehicle).

The operation of the screw jack assembly 10 will now be described.

To measure the torque weight at the towing coupling 102, the retaining pin 90 is removed to allow the spring housing 30 to move relative to the leg section 20.

By operation of the operating handle 70, the crank shaft 50 is rotated to raise or lower the main housing 80 relative to the spring housing 30 until the bubble level 89 indicates the drawbar 101 is at the design towing height (eg., substantially horizontal).

The tongue weight at the towing coupling 102 causes the compression spring 40 to be compressed between the spring housing 30 and the leg section 20, where the degree (or distance) of compression of the compression spring 40 is proportional to the tongue weight.

The spring housing 30 moves downwardly relative to the leg section 20 and the lower end of the retaining ring 33 moves to a position relative to the weight indicating indicia 28 on the leg section 20 to a position corresponding to the tongue weight, which the operation can read off from the weight indicating indicia 28, eg., 220 lbs/100 Kgs.

If necessary, the operator can reposition the load on the vehicle 100 and re-check the tongue weight to ensure it complies with legal requirements and/or the specifications for the towing system connecting the vehicle 100 to the towed vehicle. When the tongue weight has been measured, the operator lifts the drawbar 101 until the compression spring 40 is preferably at minimum compression.

The retaining pin 90 is re-engaged in the holes 34 in the retaining ring 33 on the spring housing 30 and holes 25, 26 or 27 on the leg section 20 to lock the spring housing 30 and leg section 30 together.

By suitable rotation of the crank shaft 50 by the operating handle 70, the crank shaft 50 can raise or lower the main housing 80 (and thereby the drawbar 101) relative to the spring housing 30/leg section 20 so that the screw jack assembly 10 acts in the manner of a conventional screw jack.

When the drawbar101 is connected to the towing vehicle (not shown) the crank shaft 50 can then be operated by the operating handle 70 to raise the leg section 20 (and thereby castoring jockey wheel 120 or foot 130) relative to the drawbar 101, to a raised, inoperative position.

By selective disconnection of the spring housing 30 from the leg section 20, and compression of the compression spring 40, the tongue weight at the towing coupling 102 can be consistently measured; while the screw jack assembly 10 can be quickly converted back to a conventional screw jack action.

It will be readily apparent to the skilled addressee that the present invention provides a simple, efficient, inexpensive extension to the ability of a conventional screw jack.

Various changes and modifications may be made to the embodiments described and illustrated without departing from the present invention.

I claim:

1. A screw jack assembly for a vehicle, including:
a leg section mountable at a lower end on a foot or jockey wheel;
a spring housing, having a tubular body, mountable on the vehicle, the tubular body having a cap at one end and being in co-axial telescopic arrangement with an upper end of the leg section at a second end of the tubular body;
at least one compression spring within the tubular body of the spring housing and interposed between the cap and the upper end of the leg section; and
weight indicating indicia on the leg section adjacent the second end of the tubular body of the spring housing; so arranged that:
a weight applied to the spring housing by the vehicle causes compression of the at least one compression spring;
whereby relative movement of the second end of the tubular body of the spring housing to the weight indicating indicia provides a measurement of the weight.

2. An assembly as claimed in claim 1, wherein:
the screw jack assembly is mounted on a drawbar of the vehicle, for towing, and the weight measured is the tongue weight at a towing coupling on the drawbar.

3. An assembly as claimed in claim 1, wherein
a spring guide/stop tube is connected to the cap and extends co-axially within the at least one compression spring and is operable to engage the upper end of the leg section at a maximum measurable weight.

4. An assembly as claimed in claim 1, wherein:
at least one retainer pin or safety clip is engageable in aligned holes in the tubular body of the spring housing and the leg section to releasably lock the spring housing to the leg section when the screw jack assembly is operable to raise or lower the vehicle.

5. An assembly as claimed in claim 1, wherein:
the cap has a screw-threaded bore therethrough; and a crank shaft, having a shank with external screw-threads, is rotatably engaged in the screw-threaded bore in the cap, the crank shaft having an operating handle at a distal end of the shank and a radially extending shoulder or peripheral flange between the distal end and the cap.

6. An assembly as claimed in claim 5, wherein:
a main housing has a tubular housing body which substantially encloses the spring housing and has a top end plate at an upper end with a co-axial bore therethrough, through which the crank shaft extends.

7. An assembly as claimed in claim 6, wherein:
an annular inner face on the top end plate engages the radially extending shoulder or peripheral flange on the crankshaft, whereby rotation of the crank shaft move the main housing towards, or away from, the leg section to vary the effective length of the screw jack assembly.

8. An assembly as claimed in claim 7, wherein:
a thrust bearing or bush is interposed between the annular inner face on the top end plate and the radially extending shoulder or peripheral flange on the crank shaft.

9. An assembly as claimed in claim 6, wherein:
an inwardly directed projection on the housing body of the main housing engages a complementary elongate recess in the tubular body of the spring housing to maintain the main housing and the spring housing in a telescopically slidable, but non-rotatable, relationship.

10. An assembly as claimed in claim 6, wherein:
a mounting plate projects substantially radially from the housing body of the main housing to enable the screw jack assembly to be mounted on the vehicle.

11. An assembly as claimed in claim 1, wherein:
a bubble level on the level indicator is provided on the screw jack assembly to indicate the vehicle is in a correct orientation to enable consistent measurement of the weight.

12. A vehicle fitted with the screw jack assembly claimed in claim 1.
